(19) United States
(12) Patent Application Publication
(10) Pub. No.: US 2021/0244620 A1
(43) Pub. Date: Aug. 12, 2021

(54) LIQUID MEDICINE DOSAGE DISCHARGING APPARATUS

(71) Applicant: JVM Co., Ltd., Dalseo-gu (KR)

(72) Inventor: Joon Ho KIM, Suseong-gu (KR)

(21) Appl. No.: 17/168,623

(22) Filed: Feb. 5, 2021

(30) Foreign Application Priority Data
Feb. 10, 2020 (KR) 10-2020-0015581

(51) Int. Cl. A61J 7/00; A61J 1/05; A61J 1/20

(52) U.S. Cl. CPC A61J 7/0076; A61J 2200/74; A61J 1/2048; A61J 1/05

(57) ABSTRACT

Disclosed is a liquid medicine dosage discharging apparatus configured to discharge a dosage of a liquid medicine from a liquid medicine storage portion into a prescription container to be transferred to a patient on the basis of a liquid medicine discharging request. The apparatus includes the liquid medicine storage portion in which the liquid medicine is stored, a discharge nozzle portion connected to the liquid medicine storage portion and configured to provide a discharge path of the liquid medicine, and a support portion located below the discharge nozzle portion and configured to support the prescription container. Here, the support portion grips a connection portion of the prescription container, which is exposed when a cover is removed, and supports the prescription container.

### CROSS-REFERENCE TO RELATED APPLICATION

This application claims priority to and the benefit of Korean Patent Application No. 10-2020-0015581, filed on Feb. 10, 2020, the disclosure of which is incorporated herein by reference in its entirety.

### BACKGROUND

### 1. Field of the Invention

The present invention relates to a liquid medicine dosage discharging apparatus, and more particularly, to a liquid medicine dosage discharging apparatus configured to prevent a surroundings from being contaminated by a liquid medicine which occurs when the liquid medicine is discharged into the prescription container while simultaneously distributing a dosage.

### 2. Discussion of Related Art

In general, medicines according to a prescription of a patient may include a variety of types of medicines, and one of the variety of types of medicines may be a liquid medicine.

Here, such liquid medicines are called syrup and are generally used for infants in pediatric hospitals and the like.

Meanwhile, a liquid medicine prescribed in a pediatric hospital or the like is placed in a syrup container to be transferred to a patient. In the syrup container, generally, an amount for one day to three days, on the basis of a dosage corresponding to a dose is stored.

Here, it is necessary to place a predetermined dosage of a liquid medicine a patient is to be dosed with in a syrup container. When a difference from the predetermined dosage is present, there is a possibility that a difference may be present in a dose the patient is to be dosed with.

Eventually, there is always a possibility of causing a pharmaceutical accident.

To overcome such limitations, in general, a general practitioner, a pharmacist, a physician assistant, a pharmacist assistant, or the like directly places a liquid medicine in a syrup container while manually checking each dosage and then necessarily checks the dosage after placing the liquid medicine.

Such manual preparation of medicine causes a problem of a very low preparation speed due to a feature of manual preparation of medicine so as to cause other problems such as a waste of human resources and an increase in personnel expenses.

Due to the above problems, an apparatus configured to automatically prepare a liquid medicine which is disclosed in Korean Patent Publication No. 10-2015-0040639 has been provided. However, the apparatus has a problem in that the liquid medicine leaks out while being placed in a syrup container such that a surroundings is contaminated.

Accordingly, it is inevitably necessary to research an apparatus configured to prevent contamination of a surroundings which may occur while a dosage of the liquid medicine a patient is to be dosed with is transferred to the patient as well as improving efficiency in preparation of medicine.

### SUMMARY OF THE INVENTION

The present invention is directed to providing a liquid medicine dosage discharging apparatus configured to improve efficiency and accuracy of preparation of a liquid medicine according to a dosage as well as preventing a surroundings from being contaminated.

According to an aspect of the present invention, there is provided a liquid medicine dosage discharging apparatus configured to discharge a dosage of a liquid medicine from a liquid medicine storage portion into a prescription container to be transferred to a patient on the basis of a liquid medicine discharging request. The apparatus includes the liquid medicine storage portion in which the liquid medicine is stored, a discharge nozzle portion connected to the liquid medicine storage portion and configured to provide a discharge path of the liquid medicine, and a support portion located below the discharge nozzle portion and configured to support the prescription container. Here, the support portion grips a connection portion of the prescription container and supports the prescription container.

The connection portion may be a part including a screw thread on an outer surface to allow a cover configured to seal the prescription container to be screw-coupled thereto or may be one part corresponding to an upper part of the prescription container. Also, the support portion may be inserted into a groove part of the screw thread and grip the connection portion or grips the upper part so as to support the prescription container.

The support portion may be elastically deformable to grip the connection portion.

The apparatus may further include a weight sensing portion configured to sense a weight of the prescription container when the support portion supports the prescription container.

The apparatus may further include a control portion configured to determine whether the prescription container is supported by the support portion on the basis of a sensing result obtained by the weight sensing portion after the liquid medicine dosage discharging apparatus is operated.

The control portion may control an output portion to output that the prescription container is not supported by the support portion when the liquid medicine dosage discharging apparatus is operated and the sensing result obtained by the weight sensing portion is a predetermined reference value or less.

The control portion may determine whether a dosage of the liquid medicine based on the liquid medicine discharging request is discharged into the prescription container on the basis of the sensing result obtained by the weight sensing portion.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a schematic perspective view of a liquid medicine dosage discharging apparatus according to one embodiment of the present invention;

FIG. 2 is a schematic perspective view illustrating a state in which a pivoting portion included in the liquid medicine dosage discharging apparatus according to one embodiment of the present invention is opened;

FIG. 3 is a schematic perspective view of an interior of the liquid medicine dosage discharging apparatus according to one embodiment of the present invention; and

FIGS. 4 and 5 are schematic perspective views illustrating a process in which a prescription container is supported by a support portion of the liquid medicine dosage discharging apparatus according to one embodiment of the present invention.

### DETAILED DESCRIPTION OF EXEMPLARY EMBODIMENTS

Hereinafter, detailed embodiments of the present invention will be described in detail with reference to the drawings. However, the concept of the present invention is not limited to the disclosed embodiments, and one of ordinary skill in the art may easily implement retrogressive invention or other embodiments included in the conceptual scope of the present invention through addition, change, deletion, and the like of another component without departing from the conceptual scope, which should be included in the conceptual scope of the present invention.

Also, in the drawings with respect to the embodiments, elements having the same function within the same conceptual scope will be referred to as the same reference numerals.

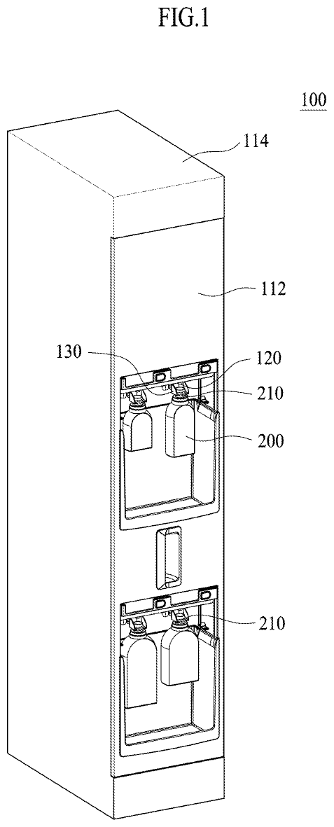

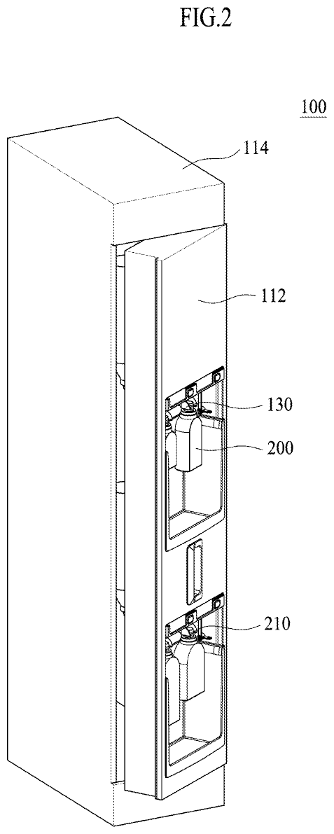

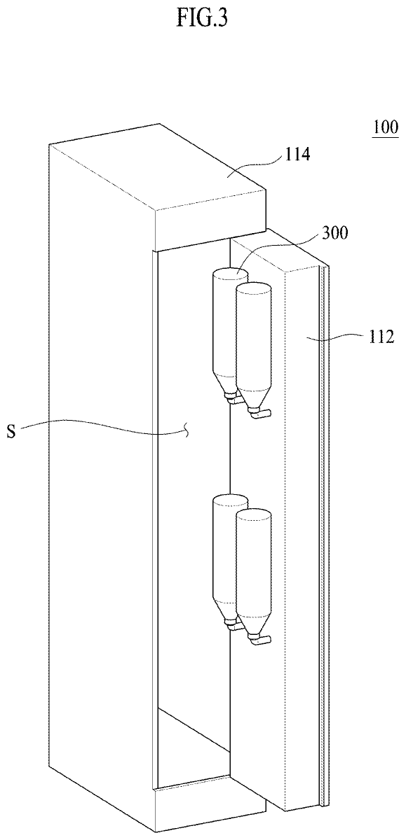

FIG. 1 is a schematic perspective view of a liquid medicine dosage discharging apparatus according to one embodiment of the present invention, FIG. 2 is a schematic perspective view illustrating a state in which a pivoting portion included in the liquid medicine dosage discharging apparatus according to one embodiment of the present invention is opened, and FIG. 3 is a schematic perspective view of an interior of the liquid medicine dosage discharging apparatus according to one embodiment of the present invention.

Referring to FIGS. 1 to 3, a liquid medicine dosage discharging apparatus 100 according to one embodiment of the present invention is configured to discharge a liquid medicine prescribed in a pediatric hospital or the like into a prescription container 200 to be transferred to a patient and may be configured to discharge a dosage of a liquid medicine from a liquid medicine storage portion 300 into the prescription container 200 on the basis of a liquid medicine discharging request (for example, a prescription of the patient or the like).

The liquid medicine dosage discharging apparatus 100 may include a pivoting portion 112, and a body portion 114, which provide an exterior, the liquid medicine storage portion 300 mounted on the pivoting portion 112 or the body portion 114, a discharge nozzle portion 120, a support portion 130, and the like.

The pivoting portion 112 and the body portion 114 are a sort of frame and may have a hexahedral shape as shown in the drawing but are not limited thereto and may have a variety of shapes.

The pivoting portion 112 may be pivotably mounted on a certain position of the body portion 114 and may expose an internal space S of the body portion 114 through pivoting.

Here, the internal space S may be a space which accommodates a plurality of such liquid medicine storage portions 300 mounted on a rear portion of the pivoting portion 112 and configured to store a liquid medicine. The liquid medicine storage portion 300 mounted on the rear portion of the pivoting portion 112 may discharge the liquid medicine through the discharge nozzle portion 120.

The discharge nozzle portion 120 may be connected to the liquid medicine storage portion 300 and configured to provide a discharge path of the liquid medicine. Here, at least one unit such as a valve and the like may control whether to discharge the liquid medicine.

Meanwhile, the prescription container 200 with the liquid medicine therein to be transferred to the patient may have a variety of sizes according to a dosage and may be a type of syrup container.

An inside of the prescription container 200 in which the liquid medicine is placed may be sealed by a cover or lid.

The prescription container 200 may be gripped using the support portion 130, and the support portion 130 may be located below the discharge nozzle portion 120.

The support portion 130 may support the prescription container 200 by gripping a connection portion 210 of the prescription container 200 which is exposed when the cover or lid for sealing the prescription container 200 is removed. The connection portion 210 may include a screw thread formed on an outer surface to allow the cover or lid to be screw-coupled thereto.

The support portion 130 may be inserted into a groove part of the screw thread and may support the prescription container 200.

Meanwhile, the connection portion 210 of the prescription container 200 which is gripped by the support portion 130 is not necessarily a part including a screw thread formed on an outer surface to allow the cover or lid to be screw-coupled thereto, and any part included in the prescription container 200 and configured to be gripped by the support portion 130 may be available.

For example, the connection portion 210 of the prescription container 200 which is gripped by the support portion 130 may be a circular groove or the like separately provided above the prescription container 200.

When the prescription container 200 is supported by the support portion 130, an inlet of the prescription container 200 is disposed to be close to an open end of the discharge nozzle portion 120 so that the liquid medicine is discharged from the liquid medicine storage portion 300 into the prescription container 200 through the discharge nozzle portion 120.

Here, the prescription container 200 may be disposed to be close to the discharge nozzle portion 120 so as to prevent an unintended leakage of the liquid medicine while being discharged and may be located while floating in the air so as to prevent contamination of the surroundings.

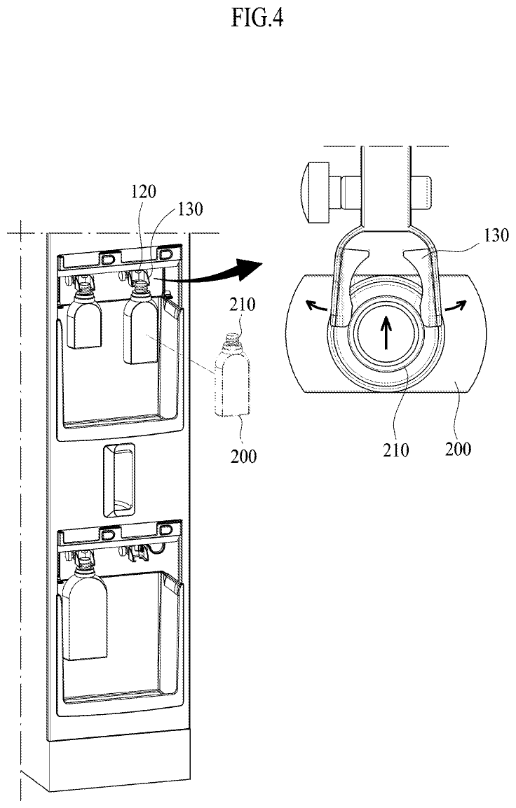

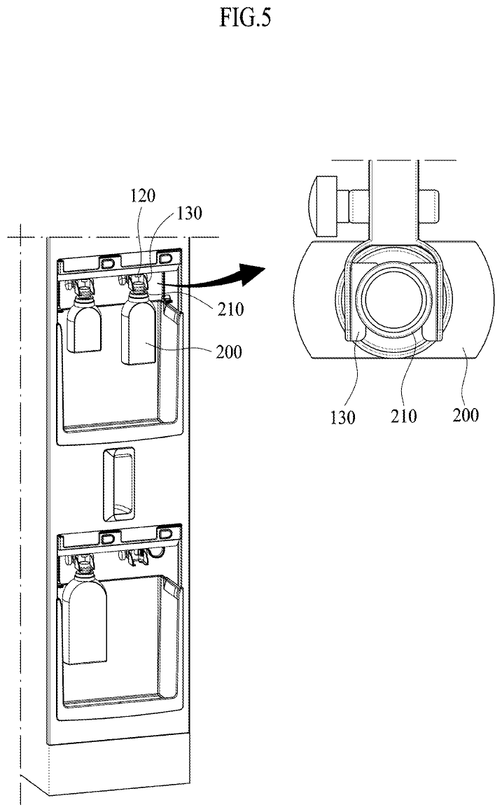

Hereinafter, a process in which the liquid medicine is discharged into the prescription container 200 will be described in detail with reference to FIGS. 4 and 5.

FIGS. 4 and 5 are schematic perspective views illustrating a process in which the prescription container is supported by the support portion of the liquid medicine dosage discharging apparatus according to one embodiment of the present invention.

Referring to FIGS. 4 and 5, when a dosage of the liquid medicine is intended to be discharged into the prescription container 200 to be transferred to the patient according to a medicine discharging request, the prescription container 200 having a size based on the dosage is mounted on the support portion 130.

Here, the support portion 130 may be elastically deformed so as to grip the connection portion 210 of the prescription container 200 as well as strengthening a support force.

Meanwhile, the liquid medicine dosage discharging apparatus 100 according to the present invention may further include a weight sensing portion (not shown) and a control portion (not shown).

When the support portion 130 supports the prescription container 200, the weight sensing portion is a type of sensor, for example, a load cell that is one of weight-measuring elements configured to sense a weight of the prescription container 200, but is not limited thereto.

When the liquid medicine dosage discharging apparatus 100 according to the present invention is operated on the basis of the medicine discharging request, the control portion may determine whether the prescription container 200 is supported by the support portion 130 on the basis of a sensing result of the weight sensing portion.

Here, the prescription container 200 may be an empty container. When the liquid medicine dosage discharging apparatus 100 is operated and the sensing result obtained by the weight sensing portion is a predetermined reference value or less, the control portion may be configured to output that the prescription container 200 is not supported by the support portion 130 through an output portion (not shown).

The output portion may include a variety of devices such as a visual device such as a display and the like, an auditory device such as a sound output device, and the like.

The predetermined reference value may be set to be different for each user and may be, for example, 2 g.

This may be set on the basis of a weight of the empty prescription container. After the liquid medicine dosage discharging apparatus 100 according to the present invention is operated on the basis of the medicine discharging request, when the weight sensing portion senses a weight of 2 g or less, the prescription container 200 is not supported by the support portion 130 yet and a situation is one in which the liquid medicine should not be discharged. Accordingly, the control portion outputs the situation through the output portion so as to allow the situation to be recognized.

When the empty prescription container 200 is supported by the support portion 130, the control portion may allow the liquid medicine to be discharged from the liquid medicine storage portion 300 into the prescription container 200 through the discharge nozzle portion 120.

Here, the weight sensing portion continuously senses a weight of the liquid medicine injected into the prescription container 200 in real time and the control portion stops a further discharge operation when a weight corresponding to the medicine discharging request is sensed.

That is, the control portion may determine whether the dosage of liquid medicine based on the liquid medicine discharging request is discharged into the prescription container 200 on the basis of the sensing result of the weight sensing portion.

Meanwhile, when the weight sensing portion senses that the empty prescription container 200 is supported by the support portion 130 after the liquid medicine dosage discharging apparatus 100 according to the present invention is operated on the basis of the medicine discharging request, the sensed weight of the empty prescription container 200 may be zeroed out.

In other words, when a weight of the empty prescription container 200 is 3 g, the control portion zeroes out 3 g to zero and then controls the discharge operation.

In the liquid medicine dosage discharging apparatus 100 according to the present invention, the dosage of the liquid medicine may be controlled by the weight sensing portion configured to sense a weight and the control portion. Also, when a dosage of a particular liquid medicine is provided as the unit of a volume on the basis of the medicine discharging request, the control portion converts the unit of the volume into the unit of a weight in consideration of density and the like of the particular liquid medicine and controls overall operations.

According to the present invention, a liquid medicine dosage discharging apparatus may prepare a dosage of a liquid medicine so as to prevent a pharmaceutical accident.

Also, a surroundings may be prevented from being contaminated by a leakage of the liquid medicine which may occur while the liquid medicine is placed in a prescription container so as to further reinforce a sanitary aspect.

Although the components and features of the present invention have been described on the basis of the embodiments of the present invention, the present invention is limited thereto. Also, it is apparent to those skilled in the art that a variety of changes and modifications may be made without departing from the concept and scope of the present invention. Therefore, it should be noted that the changes and modifications are included in the claims.

What is claimed is:

1. A liquid medicine dosage discharging apparatus configured to discharge a dosage of a liquid medicine from a liquid medicine storage portion into a prescription container to be transferred to a patient on the basis of a liquid medicine discharging request, the apparatus comprising:
the liquid medicine storage portion in which the liquid medicine is stored;
a discharge nozzle portion connected to the liquid medicine storage portion and configured to provide a discharge path of the liquid medicine; and
a support portion located below the discharge nozzle portion and configured to support the prescription container,
wherein the support portion grips a connection portion of the prescription container and supports the prescription container.

2. The apparatus of claim 1, wherein the connection portion is a part including a screw thread on an outer surface to allow a cover configured to seal the prescription container to be screw-coupled thereto or is one part corresponding to an upper part of the prescription container, and
wherein the support portion is inserted into a groove part of the screw thread and grips the connection portion or grips the upper part so as to support the prescription container.

3. The apparatus of claim 1, wherein the support portion is elastically deformable to grip the connection portion.

4. The apparatus of claim 1, further comprising a weight sensing portion configured to sense a weight of the prescription container when the support portion supports the prescription container.

5. The apparatus of claim 4, further comprising a control portion configured to determine whether the prescription container is supported by the support portion on the basis of a sensing result obtained by the weight sensing portion after the liquid medicine dosage discharging apparatus is operated.

6. The apparatus of claim 5, wherein the control portion controls an output portion to output that the prescription container is not supported by the support portion when the liquid medicine dosage discharging apparatus is operated and the sensing result obtained by the weight sensing portion is a predetermined reference value or less.

7. The apparatus of claim 5, wherein the control portion determines whether a dosage of the liquid medicine based on the liquid medicine discharging request is discharged into the prescription container on the basis of the sensing result obtained by the weight sensing portion.
